(19) United States
(12) Patent Application Publication
(10) Pub. No.: US 2010/0205082 A1
(43) Pub. Date: Aug. 12, 2010

(54) INFORMATION PROCESSING SYSTEM ENABLING COUNTERMEASURE AGAINST GLOBAL WARMING TO BE DISSEMINATED MORE EXTENSIVELY

(75) Inventors: Kunihiko YAMAZAKI, Tokyo (JP); Masao Izumoto, Tokyo (JP)

Correspondence Address: FOLEY AND LARDNER LLP;SUITE 500, 3000 K STREET NW, WASHINGTON, DC, 20007, US

(73) Assignee: NEC BIGLOBE, LTD.

(21) Appl. No.: 12/703,044

(22) Filed: Feb. 9, 2010

(30) Foreign Application Priority Data
Feb. 12, 2009 (JP) 2009-29969

(51) Int. Cl. G06Q 50/00; G06F 19/00; G06Q 10/00; G06Q 30/00

(52) U.S. Cl. 705/37; 702/24; 705/317

(57) ABSTRACT

An information processing system according to the present invention comprises a plurality of measuring instruments; and a summary server connected to the plurality of measuring instruments via a network. Each of the measuring instruments comprises a detector measuring the amount of energy usage, and an instrument controller generating an individual data piece including information on the amount of energy usage or information on carbon dioxide emission. The summary server comprises a storage storing a reference amount of usage on each of individual data pieces, and a controller which, when the individual data piece is received from the measuring instrument, calculates the amount of carbon dioxide that has been reduced as a surplus value on the basis of both the amount of carbon dioxide emission or the amounts of emission of the received individual data pieces and the reference amounts of usage of the plurality of individual data pieces.

This application is based upon and claims the benefit of priority from Japanese Patent Application No. 2009-29969 filed on Feb. 12, 2009, the content of which is incorporated by reference.

### BACKGROUND OF THE INVENTION

1. Field of the Invention

The present invention relates to an information processing system, a server device, an information processing method, and a program causing a computer to perform the method.

2. Description of Related Art

In recent years, global warming has become a problem. Efforts have been taken to reduce the amount of emission of carbon dioxide (hereinafter referred to as CO₂) on a global scale. Countries and regions cooperating with the efforts are setting target deadlines and amounts to be reduced. In order to attain targets, attention is being focused on companies that have large plants that emit a large amount of CO₂; these companies will be assigned a target value according to the amount of CO₂ emission, thereby reducing the amount of CO₂ emission.

As provision in cases where the reduction target cannot be attained, a company that is unable to attain the target will be permitted to purchase a CO₂ emission right by buying surplus amount of CO₂ that has been reduced from a company which has succeeded in reducing its CO₂ emission below that of its assigned target value.

There are known systems that allow CO₂ emission rights to be purchased more smoothly via a network such as the Internet. Examples of these systems are disclosed in Japanese Patent Laid-Open Nos. 2002-149978 and 2001-306839 (hereinafter referred to as Patent Documents 1 and 2, respectively).

However, there is a limit to reduce CO₂ emission if attention is focused on those companies having large plants that are large emitters of CO₂. Since each of ordinary households and offices has a smaller amount of CO₂ emission than manufacturing plants, great expectations of CO₂ reduction cannot be placed on these ordinary households and offices.

### SUMMARY

An exemplary object of the present invention is to provide an information processing system, a server device, an information processing method, and a program causing a computer to perform the method that allow ordinary households, offices in companies, company employees' households and the like to readily participate in CO₂ reduction efforts and enable environmental awareness of participants to be raised.

An information processing system according to an exemplary aspect of the invention includes a plurality of measuring instruments and a summary server connected to the plurality of measuring instruments via a network. Each of the plurality of measuring instruments comprises a detector measuring the amount of energy usage, and an instrument controller generating an individual data piece including information on the amount of energy usage or information on carbon dioxide emission calculated from the amount of energy usage. The summary server comprises a storage storing a reference amount of usage to be a criterion for determining whether or not the amount of carbon dioxide emission is reduced on each of the plurality of individual data pieces, and a controller which, when the individual data piece generated by the measuring instrument is received, calculates the amount of carbon dioxide that has been reduced as a surplus value on a basis of both the amount of carbon dioxide emission or the amounts of emission of the received plurality of individual data pieces and the reference amounts of usage of the plurality of individual data pieces.

The above and other objects, features and advantages of the present invention will become apparent from the following description with reference to the accompanying drawings which illustrate examples of the present invention.

### BRIEF DESCRIPTION OF THE DRAWINGS

FIG. 1 a block diagram illustrating a configuration of an information processing system according to a first exemplary embodiment;

FIG. 2 is a block diagram showing an example of a configuration of a measuring instrument shown in FIG. 1;

FIG. 3 is a block diagram showing an example of a configuration of a summary server shown in FIG. 1;

FIG. 4 is a block diagram showing an example of a configuration of a trading server shown in FIG. 1;

FIG. 5 is a block diagram showing an example of a configuration of a corporate server shown in FIG. 1;

FIG. 6 is a block diagram showing an example of a configuration of an information processing terminal shown in FIG. 1;

FIG. 7 is a sequence diagram showing a procedure of an information processing method according to the first exemplary embodiment;

FIG. 8 is a diagram showing an example of an individual data piece transmitted from the measuring instrument;

FIG. 9 is a table showing a list of the individual data pieces in Example 1;

FIG. 10 is a table showing a list of previous year data of the individual data pieces shown in FIG. 9;

FIG. 11 is a diagram showing an example of an individual screen displayed on the information processing terminal;

FIG. 12 is a block diagram showing an example of a configuration of a summary server according to a second exemplary embodiment;

FIG. 13 is a table showing a list of individual data pieces in Example 2;

FIG. 14 is a table showing a list of previous year data of the individual data pieces shown in FIG. 13; and

FIG. 15 is a block diagram for illustrating a communication system collecting individual data pieces by a method different from that of the first and second exemplary embodiments.

### DETAILED DESCRIPTION OF THE EXEMPLARY EMBODIMENTS

### First Exemplary Embodiment

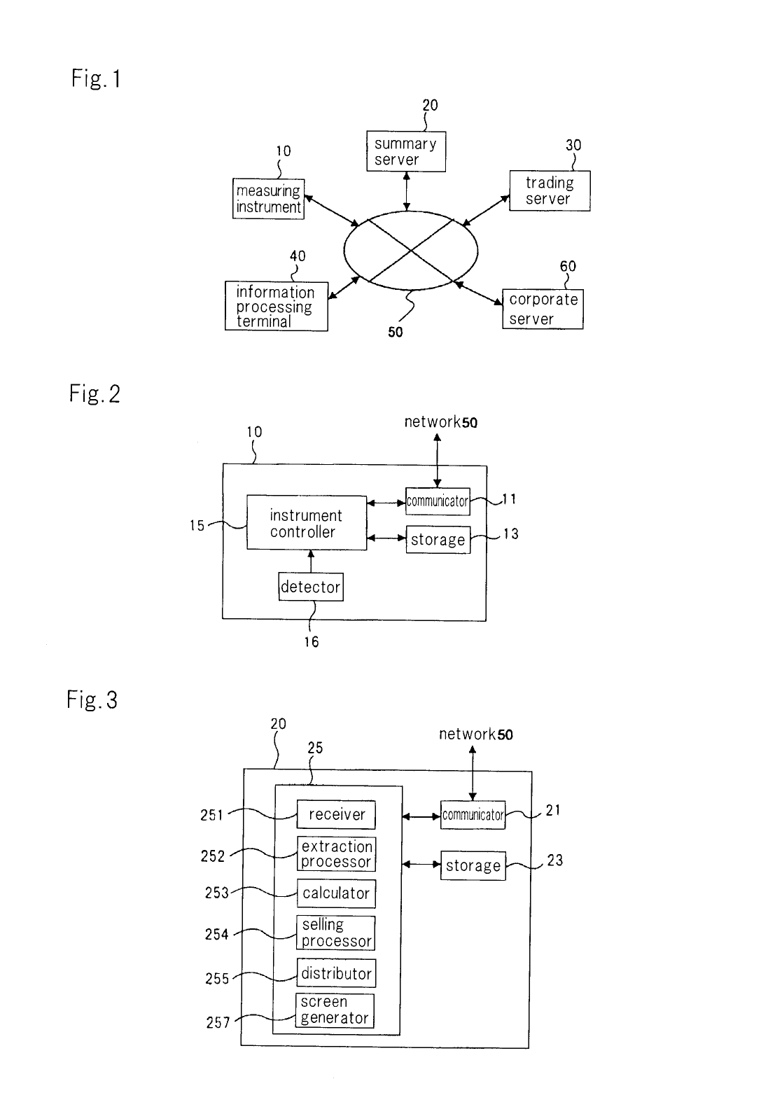

A configuration of an information processing system according to this exemplary embodiment will be described. FIG. 1 is a block diagram for illustrating the configuration of the information processing system according to this exemplary embodiment.

As shown in FIG. 1, the information processing system according to this exemplary embodiment includes summary server 20 that summarizes the amounts of CO₂ that has been reduced in households or offices, and trading server 30 that deals with the summarized amount of CO₂ that has been reduced as a trading object. Summary server 20 and trading server 30 are connected with each other via network 50.

The households and the offices participating in the efforts to reduce CO₂ are provided with measuring instruments 10 that measure the amount of CO₂ emission. Measuring instruments 10 are connected to network 50. The households and the offices here also include concepts such as business operations and branches of offices, franchise stores, households of employees working for the same company, households and corporations in a region, and small and medium businesses. Since these households and offices are equivalent to participants in groups making efforts to reduce CO₂, these households and offices are hereinafter simply referred to as “participants”. The group to which the participants belong may be the aforementioned company unit or regional unit such as Tokyo Metropolis and Chiba Prefecture. Measuring instruments 10 may be borrowed from companies that support the groups making efforts to reduce CO₂, or purchased by the participants themselves.

Information processing terminal 40, by which the participant himself/herself confirms his/her own amount of CO₂ that has been reduced, is connected to network 50. Information processing terminal 40 is an information processing device such as a personal digital assistant and a personal computer (hereinafter referred to as PC).

Corporate server 60 managed by a company wishing to obtain a CO₂ emission right for CO₂ reduction is connected to network 50. Each configuration will hereinafter be described in detail.

FIG. 2 is a block diagram showing an example of the configuration of the measuring instrument shown in FIG. 1. As shown in FIG. 2, measuring instrument 10 includes communicator 11, storage 13, detector 16 and instrument controller 15. Instrument controller 15 includes a CPU (Central Processing Unit) (not shown) performing processes according to a program, and a memory (not shown) for storing the program.

Detector 16 measures the amount of energy usage such as electric power, gas and running water, which cause the CO₂ emission, over a certain time period. Detector 16 is attached to a supply path of energy corresponding to the energy to be a measurement object. If the measurement object is electric power, detector 16 is attached to an electricity distributor or an electricity meter. If the measurement object is gas, detector 16 is attached to a gas meter. If the measurement object is running water, detector 16 is attached to a water meter.

Instrument controller 15 generates an individual data piece to which a period identifier and an ID are attached for the amount of energy usage measured by the detector 16, and transmits the individual data piece to summary server 20 via communicator 11 and network 50. The individual data piece is a data piece representing the amount of energy usage over the certain time period. The amount of energy usage of the individual data piece may be converted into the amount of CO₂ emission by instrument controller 15 at the time of recording in measuring instrument 10.

The certain time period is, for example, a monthly unit. Since the respective amounts of usage of electric power and gas are typically summarized on a monthly basis, there is an advantage that comparison with the amounts of CO₂ that has been reduced can easily be performed. Hereinafter, the description will be made regarding the certain time period as a monthly unit, unless otherwise specified. The period identifier is an identifier indicating a measurement time period. The ID is an identifier varying among measuring instruments, and serves as an identifier for identifying the participant.

Next, the configuration of summary server 20 will be described. FIG. 3 is a block diagram showing an example of the configuration of the summary server shown in FIG. 1.

As shown in FIG. 3, summary server 20 includes communicator 21, storage 23, and controller 25. Controller 25 includes receiver 251, extraction processor 252, calculator 253, and selling processor 254. Controller 25 includes a CPU (not shown) performing processes according to a program and a memory (not shown) for storing the program. The operation of executing the program by the CPU causes the virtual configuration of receiver 251, extraction processor 252, calculator 253, selling processor 254, distributor 255, and screen generator 257 in summary server 20.

Storage 23 stores data of a reference amount of usage that is a criterion for determining whether the amount of CO₂ emission is reduced or not. The reference amount of usage is a predetermined amount of usage such as the amount of usage of each individual data piece for the corresponding period of previous year, the average value or the median value of individual data pieces for all participants of the corresponding period of the same year or the like. The reason why the reference amount of usage is determined with respect to the corresponding period of the previous year or the corresponding period of the same year is that, for example, the amounts of usage of gas and electricity are different in the hot and humid summers from the amounts in the cold and dry winters on the Pacific side of Japan and thereby it is necessary that the reference value be determined with respect to the same time period during which the amount of usage is to be compared. Storage 23 accumulates the past individual data pieces that have been received from measuring instruments 10 of the respective participants.

Further, a device identifier corresponding to its own device and a terminal identifier corresponding to information processing terminal 40 are registered in storage 23. The terminal identifier varies among information processing terminals 40, and is registered with the individual data.

When summary server 20 transacts information or data with information processing terminal 40, the respective identifiers of the originator and the destination are added to the information or data to be communicated. The method of recognizing the other party of the communication may be analogous to the Internet Protocol such that the other party is identified on the basis of the header of a transmitted/received packet. It is hereinafter provided that the identifiers of the originator and the destination are attached to information and data to be transmitted/received not only between information processing terminal 40 and summary server 20 but also between any devices via network 50, the description of which will be omitted.

Receiver 251 stores in storage 23 the individual data piece have been received from each measuring instrument 10 via network 50.

Extraction processor 252 reads out the individual data pieces whose period identifiers correspond to a calculation object from among the individual data pieces stored in storage 23, and compares the amount of usage of each read individual data piece with the reference amount of usage. As a result of the comparison, the individual data pieces under the reference amount of usage, or with small amount of energy usage (amount of CO₂ emission), are extracted.

Here, if the reference amount of usage is the amount of usage for corresponding period of previous year of each individual data piece, the individual data piece of the same ID and for the corresponding period of previous year is also read out. If the reference amount of usage is the average value (may be the median value, also hereinafter) of the amounts of usage for corresponding period of the same year, the individual data pieces for the corresponding period of the same year of the entire participants in the group are read out and the average value of the amounts of usage of the read individual data pieces is calculated.

Calculator 253 calculates the difference between the reference amount of usage and the amount of usage of each of the extracted individual data pieces, totalizes the calculated differences, and stores the totalized amount as surplus value with a control number added thereto in storage 23. If the surplus value has not yet been converted into the amount of CO₂ emission, it is converted into the amount of CO₂ emission.

Selling processor 254 transmits surplus value information to trading server 30 via network 50. Upon receiving compensation information, which is information about a price for the sale of the surplus value, from a company via trading server 30, selling processor 254 stores the compensation information in storage 23. The compensation information may be a payment for the surplus value or a point representing the amount. Giving and receiving of the actual money is such that the amount of money corresponding to the compensation information is transferred into a designated financial account from the company managing corporate server 60.

Distributor 255 distributes the compensation information according to the differences between the reference amount of usage and the amounts of usage of the extracted individual data pieces, which are a basis of the surplus value, and stores a part of the compensation information with respect to the individual data piece in storage 23.

Screen generator 257 reads out the accumulated individual data pieces from storage 23 with respect to each participant, and generates a screen for displaying the amount of energy usage, the amount of energy that have been reduced, information on the reference amount of usage, a graph representing a history of past data thereof, a ranking of the individual data pieces having a large amount of energy that have been reduced according to a prescribed order and the like, for each participant. This screen is referred to as an individual screen. Further, if the participant contributes to the CO₂ that has been reduced, the compensation information may be added to the individual screen. Screen generator 257 transmits individual screen data to information processing terminal 40 via communicator 21, when receiving information for requesting the individual screen from information processing terminal 40 or when the compensation information is distributed.

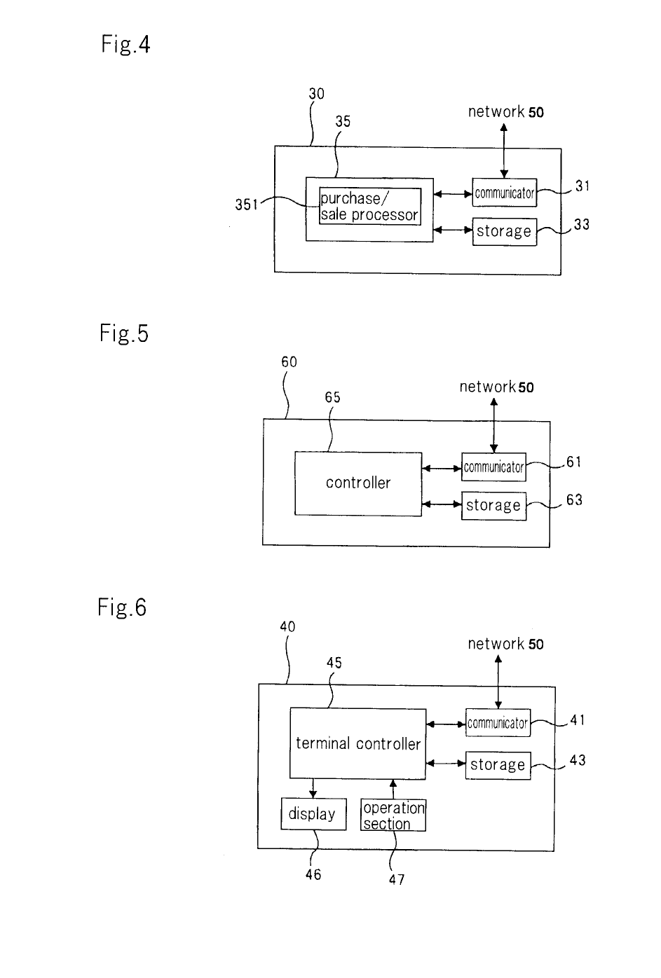

Next, the configuration of trading server 30 will be described. FIG. 4 is a block diagram showing an example of the configuration of the trading server shown in FIG. 1.

As shown in FIG. 4 trading server 30 includes communicator 31, storage 33 and controller 35. Controller 35 includes purchase/sale processor 351. Controller 35 includes a CPU (not shown) performing processes according to a program, and a memory (not shown) for storing the program. The operation of executing the program by the CPU causes the virtual configuration of purchase/sale processor 351 in trading server 30.

Upon receiving the surplus value information from summary server 20, purchase/sale processor 351 stores the information in storage 33, and discloses the information on network 50. Purchase/sale processor 351 then receives from corporate server 60 purchase request information, which is information for requesting purchase of the surplus value. When a sales contract is concluded with respect to the surplus value and when the surplus value is sold, the compensation information received from corporate server 60 is transmitted to summary server 20.

The sale may be made by connecting the purchase request with the surplus value through matching or auction between the purchase requests including the amounts of CO₂ emission to be purchased by the corporations and the like and the received surplus values.

Next, the configuration of corporate server 60 will be described. FIG. 5 is a block diagram of an example of the configuration of the corporate server shown in FIG. 1.

As shown in FIG. 5, corporate server 60 includes communicator 61, storage 63, and controller 65. Controller 65 includes a CPU (not shown) performing processes according to a program, and a memory (not shown) for storing the program.

In storage 63 the amount of CO₂ emission that the company is required to reduce and the compensation information, which is information on the compensation thereof, have previously been registered. In addition, information of a CO₂ emission quota, which is a regulated amount of CO₂ emission imposed on the company, has also been registered.

When the surplus values are disclosed on trading server 30, controller 65 checks whether or not the amount of CO₂ emission is registered in storage 63. If the amount of CO₂ emission is registered, controller 65 transmits the purchase request information to trading server 30. If the sales contract of the surplus value is concluded through trading server 30, controller 65 reads the compensation information corresponding to the surplus valve from storage 63, and transmits the compensation information to trading server 30. Controller 65 subtracts the surplus value from the amount of CO₂ emission registered in storage 63. As a result, if the amount of CO₂ emission is smaller than the CO₂ emission quota, controller 65 transmits the difference as the surplus value to trading server 30.

Since processes on trading the surplus values of CO₂ reduction and CO₂ emission rights between corporate server 60 and trading server 30 are disclosed in Patent Documents 1 and 2, a detailed description thereof will be omitted. This exemplary embodiment illustrates an example thereof.

Next, the configuration of information processing terminal 40 will be described. FIG. 6 is a block diagram showing an example of the configuration of the information processing terminal shown in FIG. 1.

As shown in FIG. 6, information processing terminal 40 includes communicator 41, storage 43, display 46, terminal controller 45 controlling each element, and operation section 47 for inputting a direction. Terminal controller 45 includes a CPU (not shown) performing processes according to a program, and a memory (not shown) for storing the program.

When instructions are made to request the individual screen via operation section 47, terminal controller 45 transmits information on requesting the individual screen to summary server 20. Upon receiving individual screen data from summary server 20, terminal controller 45 causes display 46 to display the individual screen.

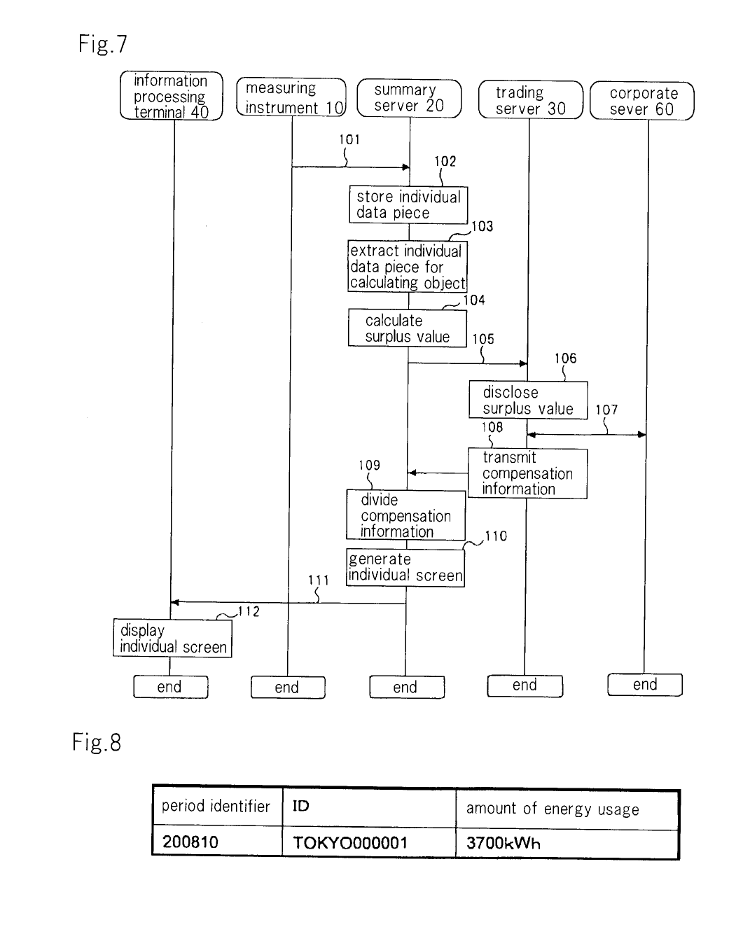

Next, a procedure of an information processing method according to this exemplary embodiment will be described. FIG. 7 is a sequence diagram showing the procedure of the information processing method according to this exemplary embodiment.

Measuring instrument 10 of each participant transmits the individual data piece to summary server 20 via communicator 11 and network 50 (step 101). When summary server 20 receives the individual data piece from each measuring instrument 10 via network 50, summary server 20 stores the individual data piece in storage 23 (step 102).

Subsequently, summary server 20 reads the individual data pieces whose period identifiers correspond to the calculation object from among the individual data pieces stored in storage 23, and compares the amount of usage of each of the read individual data pieces with the reference amount of usage. As a result of the comparison, the individual data pieces whose amounts of energy usage are smaller than the respective reference amounts of energy usage are extracted (step 103). Summary server 20 calculates the difference between the reference amount of usage and the amount of usage of each of the extracted individual data pieces, and totalizes the calculated differences, thereby calculating the surplus value (step 104). The calculated surplus value is assigned with a control number and stored in storage 23. Here, if the surplus value has not yet been converted into the amount of CO₂ emission, it is converted into the amount of CO₂ emission.

Summary server 20 transmits surplus value information to trading server 30 via network 50 (step 105). When trading server 30 receives the surplus value information from summary server 20, trading server 30 stores the information and discloses the information on network 50 (step 106). When a sales contract is concluded with respect to the surplus value with corporate server 60 and trading server 30 receives the compensation information from corporate server 60 (step 107), trading server 30 transmits the compensation information to summary server 20 (step 108).

When summary server 20 receives the compensation information from corporate server 60 via trading server 30, summary server 20 stores the compensation information in storage 23. Subsequently, summary server 20 divides the compensation information according to the differences between the reference amounts of usage and the amounts of usage of the extracted individual data pieces, which are a basis of the surplus value (step 109), and registers a part of the compensation information with respect to each of extracted individual data pieces.

Summary server 20 generates the individual screen for notification of information on reducing CO₂ to each participant (step 110). If any participant among participants in the group has the compensation information of the part, the information is also added to the individual screen of the participant. The generated individual screens are transmitted to respective information processing terminals 40 (step 111). Upon receiving the individual screen data from summary server 20, information processing terminal 40 displays the individual screen on display 46 (step 112).

In the procedure shown in FIG. 7, it has been described that summary server 20 generates the individual screen and subsequently transmits the generated individual screen to information processing terminal 40. However, summary server 20 may store the generated individual screen in storage 23; summary server 20 may read the individual screen from storage 23 and transmit the screen to information processing terminal 40, on request of the individual screen by information processing terminal 40.

An example of the processes in the aforementioned steps 103 and 104 will be described. In the example below, it is specified that the energy source that causes CO₂ emission is electric power.

### Example 1

First, an example of the individual data piece will be described. FIG. 8 is a diagram showing an example of an individual data piece. The individual data piece includes the period identifier, the ID, and information on the amount of energy usage. In the individual data piece shown in FIG. 8, the period identifier is 200810, the ID is TOKYO000001, and the amount of energy usage is 3700 kWh. The period identifier 200810 represents October, 2008. The ID TOKYO000001 represents that the participant of the individual data piece resides in Tokyo and the number is 000001 in Tokyo.

A case will be described where the reference amount of usage is the amount of usage for the corresponding period of the previous year in the first exemplary embodiment. In this case, for example, if the amount of reduction of a certain participant for October, 2008 is calculated, the amount of usage of electric power for October, 2007 is regarded as the reference amount of usage.

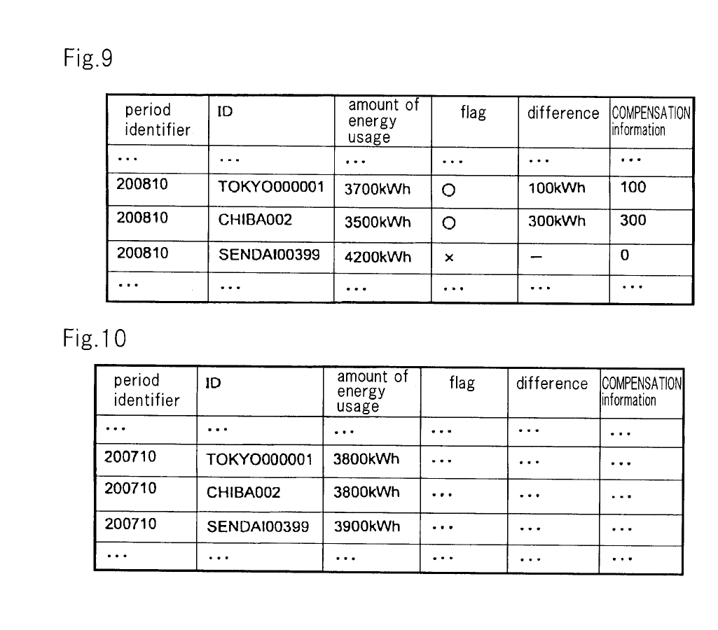

FIG. 9 is a table showing a list of the individual data pieces for 2008 stored in the summary server shown in FIG. 3. FIG. 10 is a table showing a list of the individual data pieces for 2007. Such tables are stored on a group-by-group basis.

As shown in FIGS. 9 and 10, the individual data pieces stored in summary server 20 includes a flag representing whether the amount of usage of electric power is not more than the reference amount of usage, a difference between the reference amount of usage and the amount of usage, and compensation information if the compensation has been obtained, in addition to the aforementioned three items. The difference is displayed with the plus sign if the amount of usage is smaller than the reference amount of usage; the difference is displayed with the minus sign if the amount of usage is larger than the reference amount of usage. In other words, an equation “difference=the reference amount of usage—the amount of usage” is derived.

Summary server 20 performs a calculation process as follows, with reference to the data of respective lists shown in FIGS. 9 and 10.

Extraction processor 252 of summary server 20 reads the amount of usage 3700 kWh whose period identifier is 200810 and whose ID is TOKYO000001 from the table shown in FIG. 9. Extraction processor 252 then reads, as the reference amount of usage of this individual data piece, the amount of usage 3800 kWh whose period identifier is 200710 and whose ID is TOKYO000001 from the table shown in FIG. 10. Subsequently, Extraction processor 252 compares the amount of usage 3700 kWh and the reference amount of usage 3800 kWh. Since the amount of usage is smaller than the reference amount of usage, extraction processor 252 adds a flag representing that it is not larger than the reference amount of usage to a field “NOT LARGER THAN REFERENCE” of TOKYO000001 shown in FIG. 9. Here, a circle is used as a representation of the flag. Calculator 253 calculates the difference with respect to the reference amount of usage, (3800 kWh−3700 kWh)=100 kWh, and writes the value as the difference in the table shown in FIG. 9.

Next, extraction processor 252 reads the amount of usage 3500 kWh whose period identifier is 200810 and whose ID is CHIBA002 from the table shown in FIG. 9. Extraction processor 252 then reads, as the reference amount thereof, the amount of usage 3800 kWh whose period identifier is 200710 and whose ID is CHIBA002 from the table shown in FIG. 10. Extraction processor 252 compares the amount of usage 3500 kWh and the reference amount of usage 3800 kWh. Since the amount of usage is smaller than the reference amount of usage, extraction processor 252 adds the flag representing that it is not larger than the reference. Calculator 253 calculates the difference with respect to the reference amount of usage, (3800 kWh−3500 kWh)=300 kWh, and writes the value as the difference in the table shown in FIG. 9.

Next, extraction processor 252 reads the amount of usage 4200 kWh whose period identifier is 200810 and whose ID is the next SENDAI00399 from the table shown in FIG. 9. Extraction processor 252 reads, as the reference amount thereof, the amount of usage 3900 kWh whose period identifier is 200710 and whose ID is SENDAI00399 from the table shown in FIG. 10. Extraction processor 252 compares the amount of usage 4200 kWh and the reference amount of usage 3900 kWh. Since the amount of usage is larger than the reference amount of usage, extraction processor 252 adds a flag representing that it is larger than the reference amount of usage. Here, an X symbol is used as a representation of the flag.

As described above, calculator 253 sequentially calculates the differences corresponding to the respective IDs. After calculator 253 processes all of the individual data pieces whose period identifier is 200810 in the same group, calculator 253 calculates the sum (100 kWh+300 kWh+ . . . ) of the “differences” of individual data pieces having the flag that represents that it is not larger than the reference with respect to each of ID: TOKYO000001, CHIBA002, . . . , and regards the calculated value as the surplus value.

Here, the calculation of the difference is performed on each individual data piece. Instead, the calculation may be performed on the individual data pieces whose flags represent that it is not larger than the reference, after addition of the reference flag is performed on all of the individual data pieces whose period identifier is 200810.

If there is no individual data piece for the corresponding period of previous year due to new participants and the like, an information processing system selects the reference amount of usage of the individual data piece whose family structure or company size is similar according to a predetermined procedure, or it is supposed that the amount of usage of the individual data piece when there is a new participant is larger than the reference amount of usage.

Next, a case where the reference amount of usage is the average value for the corresponding period of the same year will be described. In this case, for example, if the amount of CO₂ that has been reduced in October, 2008 is calculated, the average value of the amount of usage of electric power for all participants in October, 2008 is regarded as the reference amount of usage.

Calculator 253 refers to each individual data piece stored in storage 23. Here, the table shown in FIG. 9 is used. Calculator 253 reads the amounts of usage corresponding to the period identifier of 200810 indicating October 2008, i.e., 3700 kWh, 3500 kWh and 4200 kWh, from the table shown in FIG. 9, calculates the average value (may also be the median value) 3800 kWh, and regards the value as the reference amount of usage. Here, a case with three data pieces is used for description for the sake of simplicity. However, the number of individual data pieces is not limited thereto.

Extraction processor 252 reads the amount of usage 3700 kWh whose period identifier is 200810 and whose ID is the first TOKYO000001 from the table shown in FIG. 9. Extraction processor 252 compares the amount of usage 3700 kWh and the reference amount of usage 3800 kWh. Since the amount of usage is smaller than the reference amount of usage, extraction processor 252 adds the flag that represents that it is not larger than the reference amount of usage. Calculator 253 calculates the difference with respect to the reference amount of usage, (3800 kWh−3700 kWh)=100 kWh, and writes the value as the difference in the table shown in FIG. 9.

Extraction processor 252 reads the amount of usage 3500 kWh whose period identifier is 200810 and whose ID is the next CHIBA002 from the table shown in FIG. 9. Extraction processor 252 then compares the amount of usage 3500 kWh and the reference amount of usage 3800 kWh. Since the amount of usage is smaller than the reference amount of usage, extraction processor 252 adds the flag representing that it is not larger than the reference. Calculator 253 calculates the difference with respect to the reference amount of usage, (3800 kWh−3500 kWh)=300 kWh, and writes the value as the difference in the table shown in FIG. 9.

Extraction processor 252 reads the amount of usage 4200 kWh whose period identifier is 200810 and whose ID is the next SENDAI00399 from the table shown in FIG. 9. Extraction processor 252 compares the amount of usage 4200 kWh and the reference amount of usage 3800 kWh. Since the amount of usage is larger than the reference amount of usage, extraction processor 252 adds the flag representing that it is larger than the reference amount of usage.

As described above, calculator 253 sequentially calculates the differences corresponding to the respective IDs. After calculator 253 processes all of the individual data pieces whose period identifier is 200810 in the same group, calculator 253 calculates the sum (100 kWh+300 kWh+ . . . ) of the “differences” of individual data pieces having the flag that represents that it is not larger than the reference with respect to each of ID: TOKYO000001, CHIBA002, . . . , and regards the calculated value as the surplus value.

Here, calculation of the difference is performed on each individual data piece. Instead, the calculation may be performed on the individual data pieces whose flags represent that it is not larger than the reference, after addition of the reference flag is performed on all of the individual data pieces whose period identifier is 200810.

According to this exemplary embodiment, the summary server performs the summary process on the data transmitted from the measuring instrument from each participant in a collective manner. Thus, the amount of CO₂ that has been reduced in the entire group can be calculated even if the participant himself/herself does not measure or summarize the amount of CO₂ emission. Since the amount of CO₂ that has been reduced is small in each household/office, the amount as is cannot be dealt with by trading for CO₂ emission rights. However, the individual amounts of CO₂ that has been reduced can become an object for trading if they are collectively bundled into one amount.

A company on which a CO₂ emission quota is imposed can purchase the amount of CO₂ that has been reduced from the employees of the company and the households in its local area, and can make up for the amount exceeding the CO₂ emission quota and trade the CO₂ emission rights, which is added to the surplus amount.

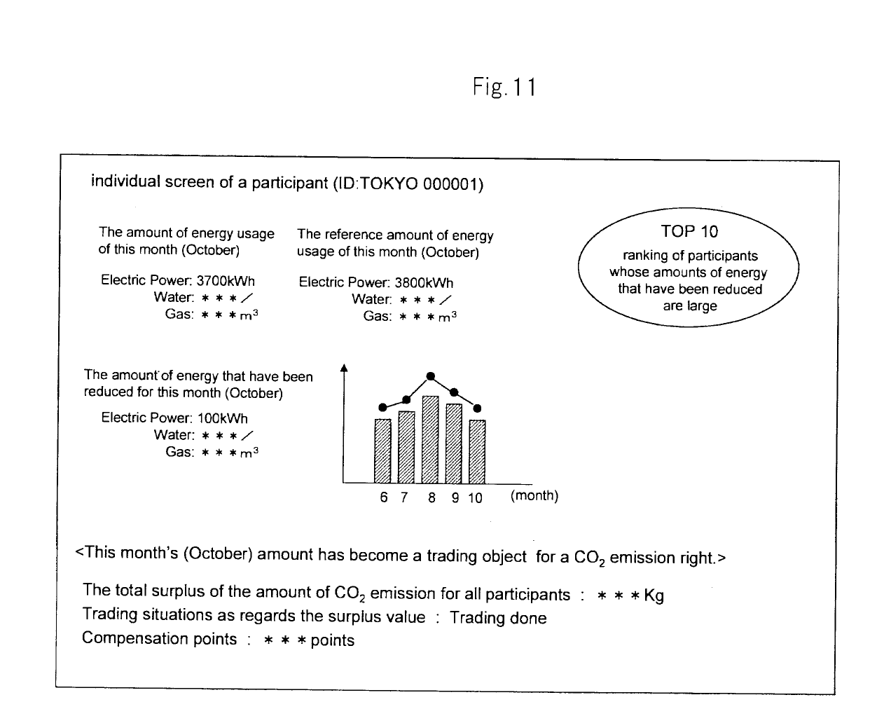

The individual screen displayed on information processing terminal 40 of the participant will be described here. FIG. 11 is a diagram showing an example of the individual screen displayed on the information processing terminal.

The amount of energy usage, the reference amount of usage, and the amount of energy that have been reduced in this month (October) are displayed from the upper part to the center part on the individual screen shown in FIG. 11 with respect to the electric power of the participant identified by ID, TOKYO000001. A bar graph and a line graph showing the variation in the amount of usage of electric power from June to October on a month-to-month basis are also displayed. More specifically, the average of the reference amount of usage of the electric power or the amount of CO₂ that has been reduced of the participant is displayed in the line graph; the amount of usage of electric power or the amount of reduction of the participant is displayed in the bar graph. The amount of usage to be displayed may be the amount of usage of water or gas.

Whether or not the amount of CO₂ that had been reduced has become a trading object is displayed on the lower part of the individual screen. Here, the sentence “This month's (October) amount has become a trading object for a CO₂ emission right.” is displayed on the screen, taking into account that the amount of CO₂ that had been reduced becomes the trading object. The total of the amount of surplus is displayed in “kg” unit in a field therebelow, “The total surplus of the amount of CO₂ emission for all participants”. A field “Trading situations as regards the surplus value” is displayed with “Trading done” as information of trading situations received from trading server 30. A field “Compensation points” is displayed with the points as the part of the compensation points.

Further, a link button for displaying a ranking of participants whose amounts of energy have been reduced are large is displayed. As an example of this, when the link button displayed on the upper right part of the individual screen shown in FIG. 11 is selected, a page, where data of each name of participant and each amount of energy that have been reduced is represented in a pair in a form by ranking a large amount of energy that have been reduced to a prescribed rank, is displayed on the screen. In this case, another piece of information capable of identifying the participants, such as nicknames or initials of the participants, may be displayed instead of displaying the names of the participants.

Since the amount of CO₂ emission and the amount of CO₂ that has been reduced are thus presented such that the participants can see this information at a glance, the participants understand very well how their efforts lead to results. An advantageous effect can also be expected in which the participants make further efforts for CO₂ reduction with enthusiasm by letting the participants obtain points and by letting the participants show the ranking that shows efforts of other participants.

Since only the participants whose amount of CO₂ emission has not exceeded the reference value are extracted, those participants who are highly sensitive to CO₂ reduction can be effectively provided with compensations and those participants whose amounts of CO₂ emission exceed the reference value are provided with an opportunity to make a more serious effort at CO₂ reduction the next time.

### Second Exemplary Embodiment

This exemplary embodiment not only extracts the individual data pieces contributing to the reduction in the amount of CO₂ emission, but also regards the entire individual data pieces in the group as objects to be summarized.

In this exemplary embodiment, operation of controller 25 of summary server 20 is partially different from that of the first exemplary embodiment, and a summary controller is added to the controller. However, the other points are analogous to those of the first exemplary embodiment. Accordingly, a detailed description on the configuration and operation analogous to those of the first exemplary embodiment will be omitted.

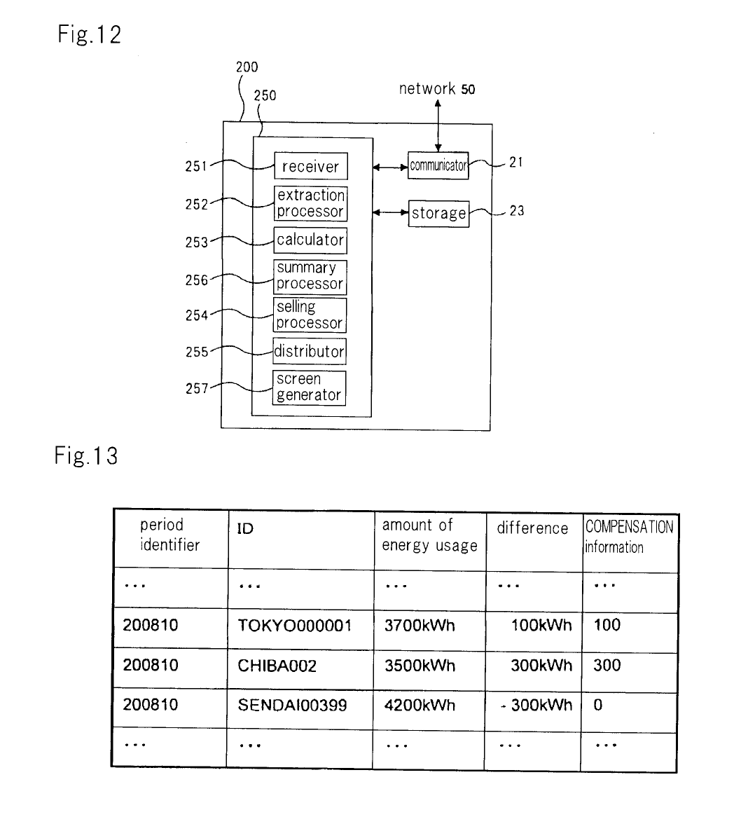

As to summary server 200 of this exemplary embodiment, points that are different from those of the first exemplary embodiment will be described. FIG. 12 is a block diagram showing an example of the configuration of the summary server of this exemplary embodiment. Controller 250 of summary server 200 shown in FIG. 12 is provided with summary processor 256.

Extraction processor 252 reads the individual data pieces whose period identifiers correspond to the calculation object and the individual data pieces whose period identifier is the corresponding period of the previous year from among the individual data pieces stored in storage 23.

Calculator 253 subtracts the sum of the amounts of usage of the individual data pieces for the time period corresponding to a calculation object from the sum of the individual data pieces for the same month of the previous year, and stores the resultant value as a surplus value in storage 23 with the control number added thereto.

Summary processor 256 determines whether the calculated surplus value is plus or minus. When the surplus value is minus, the surplus value is set to 0 and processing is terminated. When the surplus value is plus, summary processor 256 converts the surplus value into the amount of CO₂ emission if the surplus value has not yet been converted into the amount of CO₂ emission; selling processor 254 subsequently transmits the surplus value to trading server 30.

Distributor 255 divides the compensation information among individual data pieces whose amounts of usage for the time period corresponding to the calculation object are smaller than the reference amount of usage (the average, the median, and the value of corresponding period of previous year) according to the differences between the reference amount of usage and the amounts of usage. Distributor 255 then records the parts of the compensation information in storage 23 corresponding to the respective individual data pieces.

The information processing method using summary server 20 according to this exemplary embodiment will be described with reference to the sequence diagram shown in FIG. 7. Summary server 200 performs following processes in Steps 103 and 104 shown in FIG. 7.

Summary server 200 reads the individual data pieces whose period identifiers correspond to the calculation object and the individual data pieces whose period identifiers correspond to the same month in the previous year from among the individual data pieces stored in storage 23. Summary server 200 then subtracts the sum of the amounts of usage of the individual data pieces whose period identifiers correspond to the calculation object from the sum of the amounts of usage of the individual data pieces whose period identifiers correspond to the same month of the previous year, and stores the resultant value as surplus value in storage 23 with the control number added thereto.

Subsequently, summary server 200 determines whether the calculated surplus value is plus or minus. When the surplus value is minus, the surplus value is set to 0 and processing is terminated. When the surplus value is plus, summary server 200 transmits the surplus value to trading server 30. Here, if the surplus value has not yet been converted into the amount of CO₂ emission, the surplus value is converted into the amount of CO₂ emission and then transmitted to trading server 30.

Further, in step 109, summary server 200 distributes the compensation information among individual data pieces whose amounts of usage are smaller than the reference amount of usage according to the differences between the reference amount of usage and the amounts of usage. Since the other processes are analogous to those of the first exemplary embodiment, a detailed description thereof will be omitted.

An example of the processes in the aforementioned steps 103 and 104 will be described. In the example below, it is specified that the energy source that causes CO₂ emission is electric power. Since the individual data pieces are analogous to those illustrated in Example 1, a detailed description thereof will be omitted.

### Example 2

A case will be described where the reference amount of usage is the amount of usage for the corresponding period of previous year in the second exemplary embodiment. In this case, for example, if the amount of CO₂ that has been reduced of a certain participant for October, 2008 is calculated, the amount of usage of electric power for October, 2007 is regarded as the reference amount of usage.

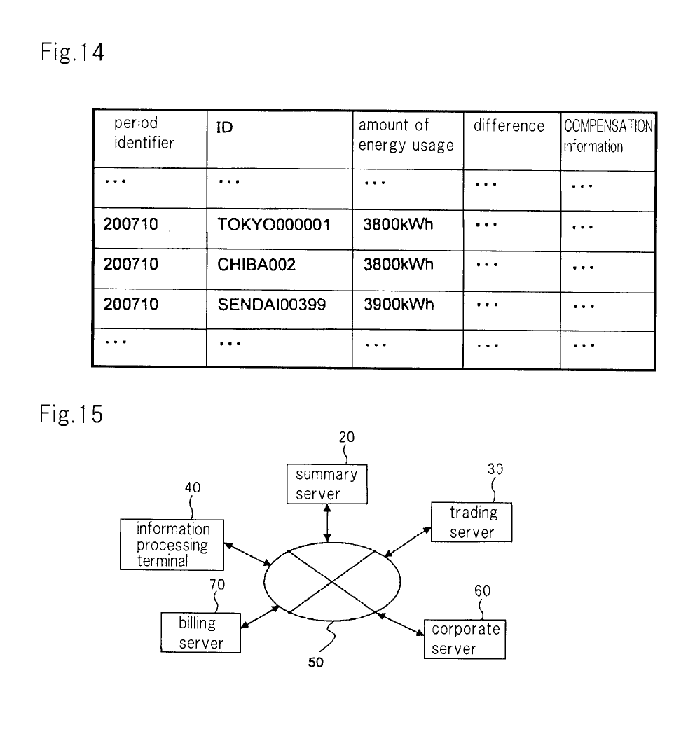

FIG. 13 is a table showing a list of the individual data pieces for 2008 stored in the summary server shown in FIG. 12. FIG. 14 is a table showing a list of the individual data pieces for 2007. Such tables are stored on a group-by-group basis.

As shown in FIGS. 13 and 14, the individual data pieces stored in summary server 200 include a difference between the reference amount of usage and the amount of usage, and the compensation information, if the compensation has been obtained, in addition to the three items shown in FIG. 8. The difference is displayed with a plus sign if the amount of usage is smaller than the reference amount of usage; the difference is displayed with a minus sign if the amount of usage is larger than the reference amount of usage. In other words, the equation “difference=the reference amount of usage—the amount of usage” is derived.

Summary server 200 performs a calculation process as follows, with reference to the data of respective lists shown in FIGS. 13 and 14.

Extraction processor 252 of summary server 200 reads the amount of usage, 3700 kWh, whose period identifier is 200810 and whose ID is TOKYO000001 from the table shown in FIG. 13. Extraction processor 252 then reads, as the reference amount of usage of this individual data piece, the amount of usage, 3800 kWh, whose period identifier is 200710 and whose ID is TOKYO000001 from the table shown in FIG. 14. Subsequently, calculator 253 calculates the difference with respect to the reference amount of usage, (3800 kWh−3700 kWh)=100 kWh, and writes the value as the difference in the table shown in FIG. 13.

Next, extraction processor 252 reads the amount of usage, 3500 kWh, whose period identifier is 200810 and whose ID is CHIBA002 from the table shown in FIG. 13. Extraction processor 252 then reads, as the reference amount of usage of this individual data piece, the amount of usage, 3800 kWh, whose period identifier is 200710 and whose ID is CHIBA002 from the table shown in FIG. 14. Subsequently, calculator 253 calculates the difference with respect to the reference amount of usage, (3800 kWh−3500 kWh)=300 kWh, and writes the value as the difference in the table shown in FIG. 13.

Next, extraction processor 252 reads the amount of usage, 4200 kWh, whose period identifier is 200810 and whose ID is SENDAI00399 from the table shown in FIG. 13. Extraction processor 252 then reads, as the reference amount of usage of this individual data piece, the amount of usage, 3900 kWh, whose period identifier is 200710 and whose ID is SENDAI00399 from the table shown in FIG. 14. Subsequently, calculator 253 calculates the difference with respect to the reference amount of usage, (3900 kWh−4200 kWh)=−300 kWh, and writes the value as the difference in the table shown in FIG. 13.

As described above, calculator 253 sequentially calculates the difference corresponding to respective IDs. After calculator 253 calculates the differences for all of the individual data pieces whose period identifier is 200810 in the same group as described above, calculator 253 calculates the sum of the “differences” of all individual data pieces of period identifier 200810 (100 kWh+300 kWh+(−300 kWh)+ . . . ), and regards the calculated value as the surplus value. When the surplus value is minus, the value cannot be dealt with by trading for CO₂ emission rights. On the other hand, when the surplus value is plus, the value can be the trading target.

The difference is calculated on each individual data piece. Instead, the surplus value may be calculated as follows: the amounts of usage of the entire individual data pieces whose period identifier is 200810 are totalized (3700 kWh+3500 kWh+4200 kWh=11,400 kWh); the amounts of usage of the individual data of 200710 corresponding thereto are totalized (3800 kWh+3800 kWh+3900 kWh=11,500 kWh); and 11,500 kWh−11,400 kWh is obtained by calculation as a difference with respect to the reference amount of usage. The obtained value may be regarded as the surplus value.

The first exemplary embodiment only deals with the individual data pieces that are not larger than the reference. However this exemplary embodiment summarizes all the individual data pieces, thereby allowing the awareness of CO₂ reduction of all the participants to be improved.

In both of the first and second exemplary embodiments, there is no penalty to be imposed on the participant who has been unable to contribute to CO₂ reduction; the participants can receive compensation when he/she has contributed, thereby improving CO₂ reduction in households and allowing global warming to be alleviated.

Further, the method of collecting the individual data pieces may be different from that of the first and second exemplary embodiments. FIG. 15 is a block diagram for illustrating a communication system collecting individual data pieces by a method that is different from that of the first and second exemplary embodiments. Here, a description will be made in comparison with the first exemplary embodiment.

In the first exemplary embodiment, the amount of energy usage is transmitted from measuring instrument 10 to summary server 20. Instead, as shown in FIG. 15, the participant himself/herself may operate information processing terminal 40 and input the amount of usage, and transmit the amount to summary server 20. Moreover, summary server 20 may use the individual data pieces that have been collected by billing server 70 for each of the companies supplying electricity, gas and running water. In the communication system shown in FIG. 15, the household or the office of each participant is not necessarily provided with measuring instrument 10.

An exemplary advantage according to the invention is as follows.

Since the amount of CO₂ that has been reduced in each of the households and offices is small, it cannot be dealt with by trading for CO₂ emission rights. The present invention however bundles the amounts of reduction into a trading object of CO₂ emission rights, thereby contributing to prevention of global warming.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing system comprising:
a plurality of measuring instruments; and
a summary server connected to said plurality of measuring instruments via a network,
wherein each of said plurality of measuring instruments comprises:
a detector measuring the amount of energy usage; and
an instrument controller generating an individual data piece including information on said amount of energy usage measured by said detector or information on carbon dioxide emission calculated from said amount of energy usage measured by said detector, and said summary server comprises:
a storage storing a reference amount of usage to be a criterion for determining whether or not the amount of carbon dioxide emission is reduced on each of said plurality of individual data pieces; and
a controller which, when said individual data piece generated by each of said plurality of measuring instruments is received, calculates the amount of carbon dioxide that has been reduced as a surplus value on a basis of both the amount of carbon dioxide emission calculated from said amounts of energy usage or said amounts of emission of said received plurality of individual data pieces and said reference amounts of usage of said plurality of individual data pieces.

2. An information processing system comprising:
a summary server comprising: a storage storing a plurality of individual data pieces including information on the amount of energy usage or the amount of carbon dioxide emission measured over a certain time period, and a reference amount of usage to be a criterion for determining whether or not the amount of carbon dioxide emission is reduced on each of said plurality of individual data pieces; and a controller calculating the amount of carbon dioxide that has been reduced as a surplus value on the basis of both the amount of carbon dioxide emission calculated from the amounts of usage or the amounts of emission of said plurality of individual data pieces and the reference amounts of usage of said plurality individual data pieces, and
a trading server comprising a controller which, upon receiving said surplus value from said summary server via a network, performs a purchase/sale process in which said surplus value is a trading object for a carbon dioxide emission right, with another device via said network.

3. The information processing system according to claim 1, wherein said controller of said summary server, when calculating said surplus value, extracts one or more individual data pieces whose amounts of carbon dioxide emission calculated from said amounts of usage or whose amounts of emission included in the same individual data piece are smaller than said respective reference amounts of usage, from among said plurality of individual data pieces, calculates a sum of differences between said reference amounts of usage and said amounts of emission of said extracted individual data pieces, and regards said sum as said surplus value.

4. The information processing system according to claim 2, wherein said controller of said summary server, when calculating said surplus value, extracts one or more individual data pieces whose amounts of carbon dioxide emission calculated from said amounts of usage or whose amounts of emission included in the same individual data piece are smaller than said respective reference amounts of usage, from among said plurality of individual data pieces, calculates a sum of differences between said reference amounts of usage and said amounts of emission of said extracted individual data pieces, and regards said sum as said surplus value.

5. The information processing system according to claim 4, wherein said storage stores information on identifiers of information processing terminals together with said respective individual data pieces, and
said controller of said summary server, upon receiving compensation information obtained by said surplus value through trading for a carbon dioxide emission right from a trading server, divides said compensation according to said extracted individual data pieces, and transmits said divided compensation information pieces to said respective information processing terminals corresponding to said extracted individual data pieces.

6. The information processing system according to claim 1, wherein said controller of said summary server, when calculating said surplus value, if the sum of said amount of carbon dioxide emission calculated from said amounts of usage of said plurality of individual data pieces or said amounts of emission included in said plurality of individual data pieces is smaller than the sum of said reference amounts of usage of said individual data pieces, regards a difference thereof as said surplus value.

7. The information processing system according to claim 2, wherein said controller of said summary server, when calculating said surplus value, if the sum of said amount of carbon dioxide emission calculated from said amounts of usage of said plurality of individual data pieces or said amounts of emission included in said plurality of individual data pieces is smaller than the sum of said reference amounts of usage of said individual data pieces, regards a difference thereof as said surplus value.

8. The information processing system according to claim 7, wherein said storage stores information on identifiers of information processing terminals together with said respective individual data pieces, and
said controller of said summary server, when receiving compensation information obtained by said surplus value through trading for a carbon dioxide emission right from a trading server, identifies one or more individual data pieces whose amounts of carbon dioxide emission calculated from said amounts of usage or whose amounts of emission included in the same individual data pieces are smaller than said respective reference amounts of usage, from among said plurality of individual data pieces, divides said compensation according to said identified individual data pieces, and transmits said divided compensation information to said respective information processing terminals corresponding to said identified individual data pieces.

9. The information processing system according to claim 1, wherein said storage stores information on identifiers of information processing terminals together with said respective individual data pieces, and
said controller of said summary server generates screen data including information comparing said amount of carbon dioxide emission calculated from said amount of usage of said individual data piece or said amount of emission included in said individual data piece with said reference amount of usage, on each of said plurality of individual data piece, and transmits said screen data to said information processing terminal corresponding to each of said plurality of individual data pieces.

10. The information processing system according to claim 2, wherein said storage stores information on identifiers of information processing terminals together with said respective individual data pieces, and
said controller of said summary server generates screen data including information comparing said amount of carbon dioxide emission calculated from said amount of usage of said individual data piece or said amount of emission included in said individual data piece with said reference amount of usage, on each of said plurality of individual data piece, and transmits said screen data to said information processing terminal corresponding to each of said plurality of individual data pieces.

11. A server device comprising:
a storage storing a plurality of individual data pieces including information on the amount of energy usage or the amount of carbon dioxide emission measured over a certain time period, and a reference amount of usage to be a criterion for determining whether or not said amount of carbon dioxide emission is reduced on each of said plurality of individual data pieces; and
a controller extracting one or more individual data pieces whose amounts of carbon dioxide emission calculated from said amounts of energy usage or whose amounts of emission included in the same individual data piece are smaller than said respective reference amounts of usage, from among said plurality of individual data pieces stored in said storage, calculating a sum of differences between said reference amounts of usage and said amounts of emission of said extracted data pieces, and regarding said sum as a trading object for a carbon dioxide emission right.

12. The server device according to claim 11, wherein said storage stores information on identifiers of information processing terminals together with said respective individual data pieces, and
said controller, upon receiving compensation information obtained by said sum through trading for a carbon dioxide emission right from a trading server, divides said compensation according to said extracted individual data pieces, and transmits said divided compensation information to said respective information processing terminals corresponding to said extracted individual data pieces.

13. A server device comprising:
a storage storing a plurality of individual data pieces including information on the amount of energy usage or the amount of carbon dioxide emission measured over a certain time period, and a reference amount of usage to be a criterion for determining whether or not said amount of carbon dioxide emission is reduced on each of said plurality of individual data pieces; and
a controller that, if the sum of said amount of carbon dioxide emission calculated from said amounts of usage of said plurality of individual data pieces or said amounts of emission included in said plurality of individual data pieces is smaller than the sum of said reference amounts of usage of said plurality of individual data pieces stored in said storage, regards a difference thereof as a trading object for a carbon dioxide emission right.

14. The server device according to claim 13, wherein said storage stores information on identifiers of information processing terminals together with said respective individual data pieces, and
said controller, upon receiving compensation information obtained by said difference through trading for a carbon dioxide emission right from a trading server, identifies one or more individual data pieces whose amounts of carbon dioxide emission calculated from said amounts of usage or whose amounts of emission included in the same individual data pieces are smaller than said respective reference amounts of usage, from among said plurality of individual data pieces, divides said compensation according to said identified individual data pieces, and transmits said divided compensation information to said respective information processing terminals corresponding to said identified individual data pieces.

15. The server device according to claim 11, wherein said storage stores information on identifiers of information processing terminals together with said respective individual data pieces, and
said controller generates screen data including information comparing said amount of carbon dioxide emission calculated from said amount of usage of the individual data piece or said amount of emission included in said individual data piece with said reference amount of usage, on each of said plurality of individual data pieces, and transmits said screen data to said information processing terminal corresponding to each of said plurality of individual data pieces.

16. The server device according to claim 13, wherein said storage stores information on identifiers of information processing terminals together with said respective individual data pieces, and
said controller generates screen data including information comparing said amount of carbon dioxide emission calculated from said amount of usage of the individual data piece or said amount of emission included in said individual data piece with said reference amount of usage, on each of said plurality of individual data pieces, and transmits said screen data to said information processing terminal corresponding to each of said plurality of individual data pieces.

17. An information processing method by a server device, comprising:
storing in a storage a plurality of individual data pieces including information on the amount of energy usage or the amount of carbon dioxide emission measured over a certain time period, and a reference amount of usage to be a criterion for determining whether or not said amount of carbon dioxide emission is reduced on each of said plurality of individual data pieces;
extracting one or more individual data pieces whose amounts of carbon dioxide emission calculated from said amounts of usage or whose amounts of emission included in the same individual data pieces are smaller than said respective reference amounts of usage, from among said plurality of individual data pieces stored in said storage; and
calculating a sum of differences between said reference amounts of usage and said amounts of emission of said extracted individual data pieces, and regarding said sum as a trading object for a carbon dioxide emission right.

18. The information processing method according to claim 17, further
storing information on identifiers of information processing terminals together with said respective individual data pieces in said storage;
upon receiving compensation information obtained by said sum through trading for a carbon dioxide emission right from a trading server, dividing said compensation according to said extracted individual data pieces; and
transmitting said divided compensation information to said respective information processing terminals corresponding to said extracted individual data pieces.

19. An information processing method by a server device, comprising:
storing in a storage a plurality of individual data pieces including information on the amount of energy usage or the amount of carbon dioxide emission measured over a certain time period, and a reference amount of usage to be a criterion for determining whether or not said amount of carbon dioxide emission is reduced on each of said plurality of individual data pieces; and
if the sum of said amount of carbon dioxide emission calculated from said amounts of usage of said plurality of individual data pieces or said amounts of emission included in said plurality of individual data pieces is smaller than the sum of said reference amounts of usage of said plurality of individual data pieces stored in said storage, regarding a difference thereof as a trading object for a carbon dioxide emission right.

20. The information processing method according to claim 19, further
storing information on identifiers of information processing terminals together with said respective individual data pieces in said storage;
upon receiving compensation information obtained by said difference through trading for a carbon dioxide emission right from a trading server, identifying one or more individual data pieces whose amounts of carbon dioxide emission calculated from said amounts of usage or whose amounts of emission included in the same individual data pieces are smaller than said respective reference amounts of usage, from among said plurality of individual data pieces;
dividing said compensation according to said identified individual data pieces; and
transmitting said divided compensation information to said respective information processing terminals corresponding to said identified individual data pieces.

21. The information processing method according to claim 17, further
storing information on identifiers of information processing terminals together with said respective individual data pieces in the storage;
generating screen data including information comparing said amount of carbon dioxide emission calculated from said amount of usage of said individual data piece or said amount of emission included in said individual data piece with said reference amount of usage, on each of said plurality of individual data pieces; and
transmitting said screen data to said information processing terminal corresponding to each of said plurality of individual data pieces.

22. The information processing method according to claim 19, further
storing information on identifiers of information processing terminals together with said respective individual data pieces in the storage;
generating screen data including information comparing said amount of carbon dioxide emission calculated from said amount of usage of said individual data piece or said amount of emission included in said individual data piece with said reference amount of usage, on each of said plurality of individual data pieces; and
transmitting said screen data to said information processing terminal corresponding to each of said plurality of individual data pieces.

23. A recording medium storing a computer-readable program for causing a computer to execute processing of:
storing in a storage a plurality of individual data pieces including information on the amount of energy usage or the amount of carbon dioxide emission measured over a certain time period, and a reference amount of usage to be a criterion for determining whether or not said amount of carbon dioxide emission is reduced on each of said plurality of individual data pieces;
extracting one or more individual data pieces whose amounts of carbon dioxide emission calculated from said amounts of usage or whose amounts of emission included in the same individual data pieces are smaller than said respective reference amounts of usage, from among said plurality of individual data pieces stored in said storage; and
calculating a sum of differences between said reference amounts of usage and said amounts of emission of said extracted individual data pieces, and regarding said sum as a trading object for a carbon dioxide emission right.

24. The recording medium according to claim 23, storing the computer-readable program for causing a computer to execute further processing of:
storing information on identifiers of information processing terminals together with said respective individual data pieces in said storage;
upon receiving compensation information obtained by said sum through trading for a carbon dioxide emission right from a trading server, dividing said compensation according to said extracted individual data pieces; and
transmitting said divided compensation information to said respective information processing terminals corresponding to said extracted individual data pieces.

25. A recording medium storing a computer-readable program for causing a computer to execute processing of:
storing in a storage a plurality of individual data pieces including information on the amount of energy usage or the amount of carbon dioxide emission measured over a certain time period, and a reference amount of usage to be a criterion for determining whether or not said amount of carbon dioxide emission is reduced on each of said plurality of individual data pieces; and
if the sum of said amount of carbon dioxide emission calculated from said amounts of usage of said plurality of individual data pieces or said amounts of emission included in said plurality of individual data pieces is smaller than the sum of said reference amounts of usage of said plurality of individual data pieces stored in said storage, regarding a difference thereof as a trading object for a carbon dioxide emission right.

26. The recording medium according to claim 25, storing the computer-readable program for causing a computer to execute further processing of:
storing information on identifiers of information processing terminals together with said respective individual data pieces in said storage;
upon receiving compensation information obtained by said difference through trading for a carbon dioxide emission right from a trading server, identifying one or more individual data pieces whose amounts of carbon dioxide emission calculated from said amounts of usage or whose amounts of emission included in the same individual data pieces are smaller than said respective reference amounts of usage, from among said plurality of individual data pieces;
dividing said compensation according to said identified individual data pieces; and
transmitting said divided compensation information to said respective information processing terminals corresponding to said identified individual data pieces.

27. The recording medium according to claim 23, storing the computer-readable program for causing a computer to execute further processing of:
storing information on identifiers of information processing terminals together with said respective individual data pieces in the storage;
generating screen data including information comparing said amount of carbon dioxide emission calculated from said amount of usage of said individual data piece or said amount of emission included in said individual data piece with said reference amount of usage, on each of said plurality of individual data pieces; and
transmitting said screen data to said information processing terminal corresponding to each of said plurality of individual data pieces.

28. The recording medium according to claim 25, storing the computer-readable program for causing a computer to execute further processing of:
storing information on identifiers of information processing terminals together with said respective individual data pieces in the storage;
generating screen data including information comparing said amount of carbon dioxide emission calculated from said amount of usage of said individual data piece or said amount of emission included in said individual data piece with said reference amount of usage, on each of said plurality of individual data pieces; and
transmitting said screen data to said information processing terminal corresponding to each of said plurality of individual data pieces.
